(19) United States
(12) Patent Application Publication
(10) Pub. No.: US 2005/0274615 A1
(43) Pub. Date: Dec. 15, 2005

(54) Gas sensing element

(75) Inventors: Susumu Naito, Kariya-shi (JP); Hiroo Imamura, Okazaki-shi (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 11/151,593

(22) Filed: Jun. 14, 2005

(30) Foreign Application Priority Data
Jun. 14, 2004 (JP) 2004-175368
Apr. 14, 2005 (JP) 2005-117356

(51) Int. Cl. G01N 27/26

(52) U.S. Cl. 204/424; 204/426

(57) ABSTRACT

A gas sensing element includes a solid electrolyte body having oxygen ionic conductivity, a measured gas side electrode provided on one surface of the solid electrolyte body, and a reference gas side electrode provided on the other surface of the solid electrolyte body. The measured gas side electrode is positioned in a chamber space. The gas sensing element has an introducing hole connecting the chamber space to a measured gas atmosphere outside of the gas sensing element. The introducing hole is filled with a porous member having an average pore diameter of 2 to 30 μm.

### CROSS-REFERENCE TO RELATED APPLICATION

This application is based upon and claims the benefit of priority from earlier Japanese Patent Application No. 2004-175368 filed on Jun. 14, 2004 and the Japanese Patent Application No. 2005-117356 filed on Apr. 14, 2005 so that the descriptions of which are incorporated herein by reference.

### BACKGROUND OF THE INVENTION

The present invention relates to a gas sensing element used for controlling the combustion in an internal combustion engine, such as an automotive engine.

A gas sensor (e.g. an A/F sensor), provided in an exhaust system of an automotive internal combustion engine, detects an air-fuel ratio based on the oxygen concentration in exhaust gas. For example, it is possible to perform a combustion control of the internal combustion engine based on the detected air-fuel ratio. This is generally referred to as exhaust gas control feedback system. Especially, to efficiently purify the exhaust gas with a ternary catalyst, it is important to adjust the air-fuel ratio to a specific value in a combustion chamber of the automotive internal combustion engine.

The above-described gas sensor includes a gas sensing element capable of detecting the oxygen concentration of an exhaust gas. The gas sensing element includes, as shown in FIG. 19, a solid electrolyte body 91 having oxygen ionic conductivity. A measured gas side electrode 92 is provided on one surface of the solid electrolyte body 91. A reference gas side electrode 93 is provided on the other surface of the solid electrolyte body 91. The measured gas side electrode 92 is positioned in a chamber space 94. The chamber space 94 is covered with a porous diffusion resistance layer 95 and a dense shielding layer 97. According to the arrangement of this gas sensing element, a measured gas is introduced into the chamber space 94 via the porous diffusion resistance layer 95 (refer to Japanese patent application Laid-open No. 2000-65782 corresponding to the U.S. Pat. No. 6,340,419).

Furthermore, a reference gas chamber forming layer 98 is laminated on another surface of the solid electrolyte body 91 where the reference gas side electrode 93 is formed, to form a reference gas chamber 980. A heater board 21, on which a heating element 22 is provided, is laminated on the reference gas chamber forming layer 98.

However, the inventors have found a phenomenon that, after a gas sensor is left for a long time in an exhaust pipe of an automotive vehicle, a gas sensing element (e.g. A/F sensing element) incorporated in this gas sensor causes a rich shift in the sensor output during 10 seconds or more after the internal combustion engine starts its operation. This phenomenon (i.e. rich shift) is a phenomenon that the air-fuel ratio obtained based on a detection value of the gas sensing element is offset toward the rich side than an actual air-fuel ratio value of the internal combustion engine.

This rich shift phenomenon is a major cause of unstable combustion occurring in an automotive internal combustion engine. More specifically, when a rich signal is sent to an engine control system, this system operates a fuel supplying device to shift the air-fuel ratio of the engine to a lean side (i.e. to the direction increasing the air amount relative to the fuel amount). However, the actual state of exhaust gas is leaner than the indication value of the air-fuel ratio sensor. Accordingly, the engine may cause misfires and will stop. Furthermore, when the air-fuel ratio of the engine is greatly deviated from a target control point, the exhaust gas discharged from this engine will contain a great amount of NOx or other air pollution gases.

The inventors have conducted detailed investigations on this rich shift phenomenon, and found that the substance adhering to the gas sensing element and inducing the rich shift phenomenon is H₂O, i.e. water vapors (water), and also that almost all of the water adherers to the porous diffusion resistance layer 95. The inventors have also confirmed that the gas sensing element being left in a highly-humid atmosphere tends to cause the rich shift phenomenon.

The above-described rich shift phenomenon is believed to occur and disappear according to the following process. First, a rich shift occurs when the gas sensor is left in a highly-humid atmosphere such as an exhaust pipe of an automotive internal combustion engine. More specifically, as understood from the illustration shown in FIG. 19, when the gas sensor is left in the highly-humid atmosphere, vaporized water (i.e. water vapors) possibly enters into the gas sensing element 9 incorporated in the gas sensor. The physical adsorption and/or chemical adsorption of the water will chiefly occur at the porous diffusion resistance layer 95 of the gas sensing element 9.

When the gas sensing element 9 is heated, the water removes and vaporizes from the porous diffusion resistance layer 95. The vaporized water, i.e. water vapors, then causes cubical expansion due to the heat and tends to exit out of the porous diffusion resistance layer 95. However, the porous diffusion resistance layer 95 has a significant diffusion resistance. A relatively long time will be required until the water vapors are completely discharged from the porous diffusion resistance layer 95.

Accordingly, the water vapor pressure increases inside the gas sensing element 9 (especially, in the vicinity of the measured gas side electrode 92). The oxygen partial pressure decreases relatively. This is the reason why the rich shift occurs in the output of the gas sensor. The water vapors exit slowly to the outside through the porous diffusion resistance layer 95. Meanwhile, the ambient exhaust gas enters inside the gas sensing element 9. Accordingly, the rich shift gradually disappears with elapsing time and the sensor output returns to an ordinary value.

In this manner, it is believed that such a sudden cubical expansion of water vapors occurs due to removal and vaporization of the water and induces a large rich shift equivalent to 1 to 2 in terms of air-fuel ratio difference (ΔA/F). If the gas sensor is kept in a dry atmosphere, such a problem will not occur. However, automotive vehicles are stationarily parked for a long time. The inside space of an exhaust pipe of the engine is usually filled with a highly-humid atmosphere, since the exhaust gas contains a greater amount of water emission as combustion production. Thus, the gas sensor is inevitably subjected to such a highly-humid environment and accordingly tends to cause the above-described rich shift phenomenon. Although the inventors have confirmed that limiting-current type oxygen sensing elements (e.g. A/F sensing elements) cause the rich shift phenomenon according to the above-described mechanism, it has also been confirmed that the rich shift phenomenon occurs in an oxygen concentration electromotive type oxygen sensing element according to the similar mechanism (refer to the Japanese Patent Publication No. 7-111412 corresponding to the U.S. Pat. No. 4,836,906).

### SUMMARY OF THE INVENTION

In view of the above-described conventional problems, the present invention has an object to provide a gas sensing element capable of suppressing the rich shift phenomenon appearing in the sensor output.

In order to accomplish the above and other related objects, the present invention provides a gas sensing element including a solid electrolyte body having oxygen ionic conductivity, a measured gas side electrode provided on one surface of the solid electrolyte body, a reference gas side electrode provided on the other surface of the solid electrolyte body, and a chamber space in which the measured gas side electrode is positioned. Furthermore, the gas sensing element of this invention has an introducing hole connecting the chamber space to a measured gas atmosphere outside of the gas sensing element, and the introducing hole is filled with a porous member having an average pore diameter of 2 to 30 μm.

Next, functions and effects of the present invention will be explained. As defined above, the gas sensing element according to this invention has the porous member having the average pore diameter equal to or greater than 2 μm. This is effective in reducing the diffusion resistance. And, the water adhering to the porous member can be promptly discharged to the outside.

More specifically, water vapors contained in the measured gas atmosphere possibly adhere to the porous member. When the internal combustion engine starts its operation, the water can remove from the porous member due to the heat. The water can promptly exit to the outside because the porous member has a relatively larger average pore diameter as described above. Hence, the gas sensing element of this invention can prevent the water vapor pressure from undesirably increasing in the chamber space and also can reduce or eliminate the rich shift in the sensor output.

Furthermore, having the average pore diameter equal to or greater than 2 μm brings an effect of reducing the surface area of the porous member exposed to the measured gas, an effect of reducing an adsorption amount of the water in the measured gas, and an effect of suppressing generation of the rich shift phenomenon.

Furthermore, the gas sensing element according to this invention has the porous member having the average pore diameter equal to or less than 30 μm. This is effective in suppressing the amount of harmful substances (including Pb, P, and S) which may enter into the chamber space. Accordingly, the electrode materials can be prevented from being exposed to such harmful substances.

As described above, the present invention can provide a gas sensing element capable of suppressing the rich shift phenomenon appearing in the sensor output.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a cross-sectional view showing a gas sensing element in accordance with a first embodiment of the present invention;

FIG. 2 is an exploded perspective view showing the gas sensing element in accordance with the first embodiment of the present invention;

FIG. 3 is an exploded perspective view showing a chamber forming layer, a shielding layer, and a porous member of the gas sensing element in accordance with the first embodiment of the present invention;

FIG. 4 is a cross-sectional view showing an introducing hole, the porous member, and peripheral members of the gas sensing element in accordance with the first embodiment of the present invention;

FIG. 5 is a cross-sectional view showing an introducing hole, a porous member, and peripheral members of a gas sensing element in accordance with a second embodiment of the present invention;

FIG. 6 is a cross-sectional view showing an introducing hole, a porous member, and peripheral members of another gas sensing element in accordance with the second embodiment of the present invention;

FIG. 7 is a graph showing a relationship between the grinding amount of the shielding layer and the sensor output of the gas sensing element in accordance with the second embodiment of the present invention;

FIG. 8 is an exploded perspective view showing a gas sensing element in accordance with the third embodiment of the present invention;

FIG. 9 is an exploded perspective view showing a chamber forming layer, a shielding layer, and a porous member of a gas sensing element in accordance with the third embodiment of the present invention;

FIG. 10 is an exploded perspective view showing a chamber forming layer, a shielding layer, and a porous member of a gas sensing element in accordance with a fourth embodiment of the present invention;

FIG. 11 is an exploded perspective view showing a chamber forming layer, a shielding layer, and a porous member of another gas sensing element in accordance with the fourth embodiment of the present invention;

FIG. 12 is a cross-sectional view explaining an adjusting method of sensor output for the gas sensing element in accordance with the fourth embodiment of the present invention;

FIG. 13 is an exploded perspective view showing a chamber forming layer, a shielding layer, and a porous member of a gas sensing element in accordance with a fifth embodiment of the present invention;

FIG. 14 is an exploded perspective view showing a chamber forming layer, a shielding layer, and a porous member of another gas sensing element in accordance with the fifth embodiment of the present invention;

FIG. 15 is a cross-sectional view explaining an adjusting method of sensor output for the gas sensing element in accordance with the fifth embodiment of the present invention;

FIG. 16 is a graph showing a relationship between the average pore diameter of the porous member and the rich shift amount based on experimental data;

FIG. 17 is a graph showing a relationship between the average pore diameter of the porous member and the rich shift amount based on experimental data;

FIG. 18 is a graph showing a relationship between the porosity of the porous member and the rich shift amount based on experimental data; and

FIG. 19 is a cross-sectional view showing a conventional gas sensing element.

### DESCRIPTION OF THE PREFERRED EMBODIMENTS

As a best mode of the present invention, the inventors of this patent application provide a gas sensing element including a solid electrolyte body having oxygen ionic conductivity, a measured gas side electrode provided on one surface of the solid electrolyte body, a reference gas side electrode provided on the other surface of the solid electrolyte body, and a chamber space in which the measured gas side electrode is positioned. Furthermore, the gas sensing element of this invention has an introducing hole connecting the chamber space to a measured gas atmosphere outside of the gas sensing element, and the introducing hole is filled with a porous member having an average pore diameter of 2 to 30 μm.

The above-described gas sensing element according to the present invention is preferably installed in an exhaust pipe of an automotive engine or any other type of internal combustion engine. For example, the gas sensing element of the present invention is an air-fuel ratio sensing element incorporated in an air-fuel ratio sensor of an exhaust gas feedback system, an oxygen sensing element capable of measuring the oxygen concentration in an exhaust gas, or a NOx sensing element capable of checking the concentration of NOx or other air pollution substances to detect deteriorated conditions of a ternary catalyst installed in the exhaust pipe.

If the above-described porous member has the average pore diameter less than 2 μm, the water adhering to the porous member will not be able to promptly exit out of the gas sensing element. It will be difficult to suppress generation of the rich shift phenomenon appearing in the output of the gas sensing element. Furthermore, if the porous member has the average pore diameter exceeding 30 μm, harmful substances contained in the exhaust gas will penetrate into the porous member and reach the measured gas side electrode. The electrode material will be contaminated by these harmful substances. The sensor characteristics will be worsened. Furthermore, the number of the above-described introducing hole is not limited to only one. The number of the above-described porous member is not limited to only one.

Furthermore, it is preferable that the average pore diameter of the porous member is equal to or greater than 5 μm. According to this arrangement, the diffusion resistance can be sufficiently reduced. The water having adhered to the porous member can be promptly and sufficiently discharged to the outside. Furthermore, the surface area of the porous member to be exposed to the measured gas becomes smaller. The adsorption amount of the water in the measured gas can be reduced. Generation of the rich shift phenomenon can be sufficiently suppressed.

Furthermore, it is preferable that the porous member has the porosity of 30 to 75% by volume. According to this arrangement, it becomes possible to obtain uniform distribution of pores with less dispersion. Usually, to obtain the pore diameter equal to or greater than 2 μm, it is one way to use a porous member having adequate grain diameters. It is another way to mix resin grains having adequate grain diameters into a green sheet of the diffusion resistance layer and let the resin grains disappear in the sintering process so that the required pores are formed. In this case, it is desirable that the dispersion of pores is uniform. When the porosity is equal to or near 75% by volume, the layout structure of resin grains being filled in the green sheet of the diffusion resistance layer is almost densest. Uniform distribution of the pores with less dispersion can be obtained when the sintering operation is finished. Furthermore, setting the porosity in the above-described range ensures the effect of sufficiently discharging the water in the beginning of engine operations.

On the other hand, if the above-described porosity is less than 30% by volume, it will become difficult to obtain uniform distribution of pores with less dispersion. Therefore, in the beginning of engine operations, it will be difficult to sufficiently obtain the effects of the present invention. Furthermore, if the above-described porosity exceeds 75% by volume, the strength of the porous member will be insufficient and accordingly the gas sensing element will not be able to have excellent durability.

Furthermore, it is preferable that porous member has the porosity of 50 to 75% by volume. According to this arrangement, it is possible to surely obtain the uniform distribution of pores with less dispersion and sufficiently discharge the water in the beginning of engine operations. Accordingly, generation of the rich shift phenomenon can be surely suppressed.

Furthermore, it is preferable that the introducing hole has a cross-sectional area changing in accordance with the distance from the chamber space. According to this arrangement, output adjustment for the gas sensing element can be easily performed. The sensor output is determined according to the diffusion resistance of the above-described porous member. The diffusion resistance changes depending on the gas introducing cross-sectional area and the diffusion distance. The gas introducing cross-sectional area depends on the cross-sectional area of the introducing hole. The diffusion distance changes depending on the length of the introducing hole. Namely, the sensor output becomes larger when the cross-sectional area of the introducing hole is large and the length of the introducing hole is short. Hence, grinding the outer surface of the gas sensing element toward the chamber space at the region including the introducing hole makes it possible to adjust the length of the introducing hole (i.e. adjust the diffusion distance) and, as a result, makes it possible to adjust the sensor output.

If the cross-sectional area of the introducing hole is constant irrespective of the distance from the chamber space, the sensor output will become larger linearly in accordance with the grinding amount. To the contrary, changing the cross-sectional area of the introducing hole in accordance with the distance from the chamber space as described above makes it possible to adjust the change (increase) rate of the sensor output relative to the grinding amount. With this arrangement, it becomes possible to optimize the increase rate of the sensor output in accordance with the grinding accuracy.

Furthermore, it is preferable that the gas sensing element includes a chamber forming layer having an open portion for forming the chamber space and a shielding layer covering the chamber forming layer. The chamber forming layer and the shielding layer are successively laminated on the one surface of the solid electrolyte body. And, each of the chamber forming layer and the shielding layer is made of a gas impermeable dense material. According, the gas sensing element according to this arrangement is easy to manufacture and excellent in strength.

Furthermore, it is preferable that the introducing hole is formed in the shielding layer. According to this arrangement, the above-described introducing hole can be easily formed. Furthermore, the above-described introducing hole can be formed, for example, as a pinhole.

Furthermore, it is preferable that an overall cross-sectional area T at the narrowest portion of the introducing hole and a thickness D of the shielding layer are in a relationship of 0.005≦TD²≦=0.5. According to this arrangement, the measured gas can be sufficiently introduced into the above-described chamber space. The gas sensing element can have sufficient strength. On the other hand, if the ratio T/D² is less than the above range (i.e. T/D²<0.005), the measured gas will not be sufficiently introduced into the above-described chamber space. Furthermore, if the ratio T/D² is greater than the above range (i.e. T/D²>0.5), the gas sensing element will not be able to have excellent strength. The above-described “cross-sectional area T” is a cross-sectional area at the narrowest portion of the introducing hole, obtained when the shielding layer is cut along a surface normal to the axial direction of the introducing hole.

Furthermore, it is preferable that an overall cross-sectional area T at the narrowest portion of the introducing hole and an area S of the shielding layer facing to the chamber space are in a relationship of 1.0×10⁻⁵≦T/S≦5.0×10⁻³. According to this arrangement, the measured gas can be sufficiently introduced into the above-described chamber space. The gas sensing element can have sufficient strength. On the other hand, if the ratio T/S is less than the above range (i.e. T/S<1.0×10⁻⁵), the measured gas will not be sufficiently introduced into the above-described chamber space. Furthermore, if the ratio T/S is greater than the above range (i.e. T/S>5.0×10⁻³), the gas sensing element will not be able to have excellent strength.

Furthermore, it is preferable to form the introducing hole in the chamber forming layer. According to this arrangement, the introducing hole can be selected from various kinds of introducing holes (which are mutually different in their shapes). For example, the above-described introducing hole can be formed as a plurality of slits.

Furthermore, it is preferable that an overall cross-sectional area T at the narrowest portion of the introducing hole and the length L of the introducing hole are in a relationship of 0.01≦T/L²≦=0.8. According to this arrangement, the measured gas can be sufficiently introduced into the above-described chamber space. The gas sensing element can have sufficient strength. In this case, the above-described “cross-sectional area T” is a cross-sectional area at the narrowest portion of the introducing hole, obtained when the chamber forming layer is cut along a surface normal to the axial direction of the introducing hole.

On the other hand, if the ratio T/L² is less than the above range (i.e. T/L²<0.01), the measured gas will not be sufficiently introduced into the above-described chamber space. Furthermore, if the ratio T/L² is greater than the above range (i.e. T/L²>0.8), the occupation area of the porous member relative to the chamber forming layer becomes larger and accordingly the gas sensing element will not be able to have excellent strength. For example, insufficient strength of the chamber forming layer induces undesirable exfoliations which may occur in the process of grinding the surface of the gas sensing element. For example, exfoliations will occur along the boundary between the chamber forming layer and the shielding layer or along the boundary between the chamber forming layer and the solid electrolyte body. Furthermore, the cross-sectional area at the above-described narrowest portion becomes extremely larger, or the length of the introducing hole becomes extremely smaller. Therefore, the diffusion resistance will decrease too excessively to obtain a desired sensor output (i.e. a desired limiting-current value).

Furthermore, a preferable ratio of the introducing hole to the shielding layer is in a range of 0.005 to 0.5% in volume. According to this arrangement, the measured gas can be sufficiently introduced into the above-described chamber space. The gas sensing element can have sufficient strength. Furthermore, a preferable ratio of the introducing hole to the chamber forming layer is in a range of 1 to 20% in volume. According to this arrangement, the measured gas can be sufficiently introduced into the above-described chamber space. The gas sensing element can have sufficient strength.

Hereinafter, practical examples of the gas sensing element according to the present invention will be explained.

### FIRST EMBODIMENT

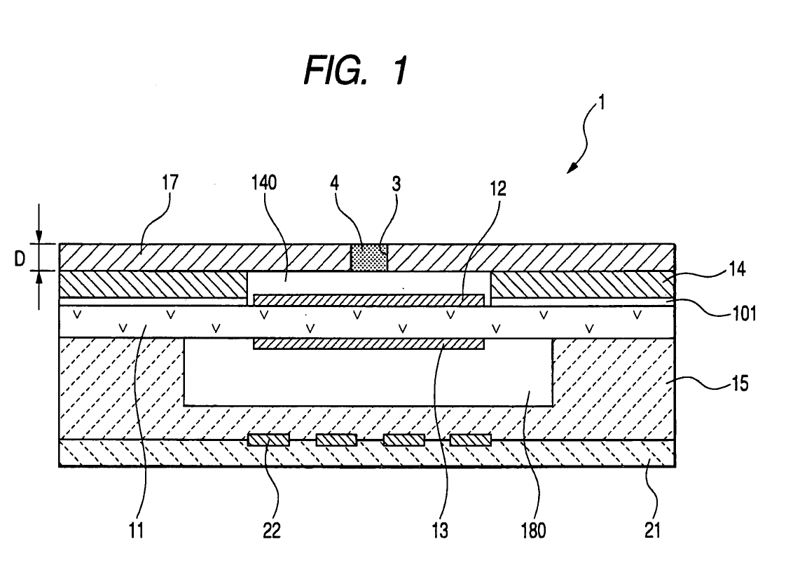

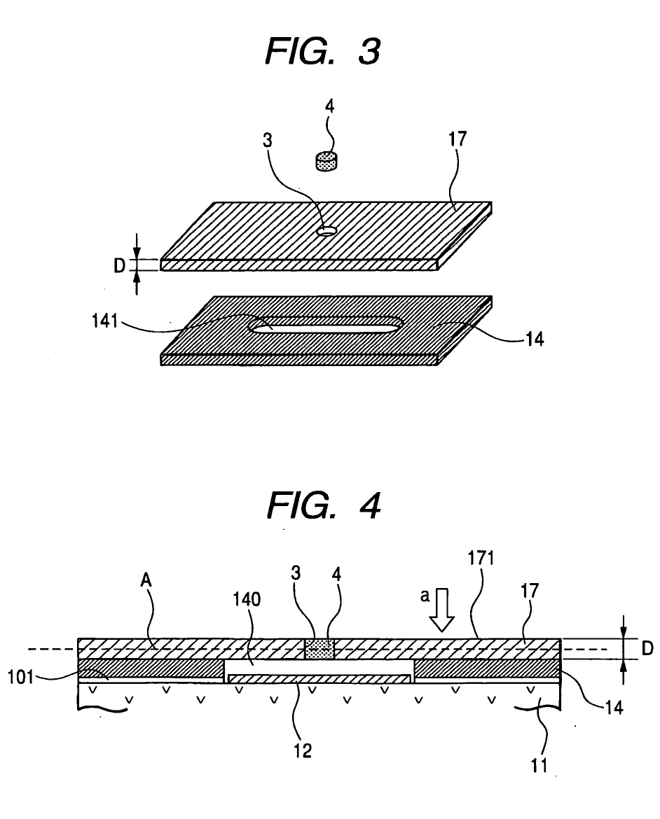

A gas sensing element in accordance with a first embodiment of the present invention will be explained with reference to FIGS. 1 to 4. A gas sensing element 1 of this embodiment includes a solid electrolyte body 11 having oxygen ionic conductivity, a measured gas side electrode 12 provided on one surface of solid electrolyte body 11, and a reference gas side electrode 13 provided on the other surface of solid electrolyte body 11. Furthermore, the gas sensing element 1 includes a chamber space 140 in which the measured gas side electrode 12 is positioned. The gas sensing element 1 has an introducing hole 3 connecting the chamber space 140 to a measured gas atmosphere outside of the gas sensing element 1. The introducing hole 3 is filled with the porous member 4 having an average pore diameter equal to or greater than 2 μm. Furthermore, the porous member 4 has the porosity of 30 to 75% by volume.

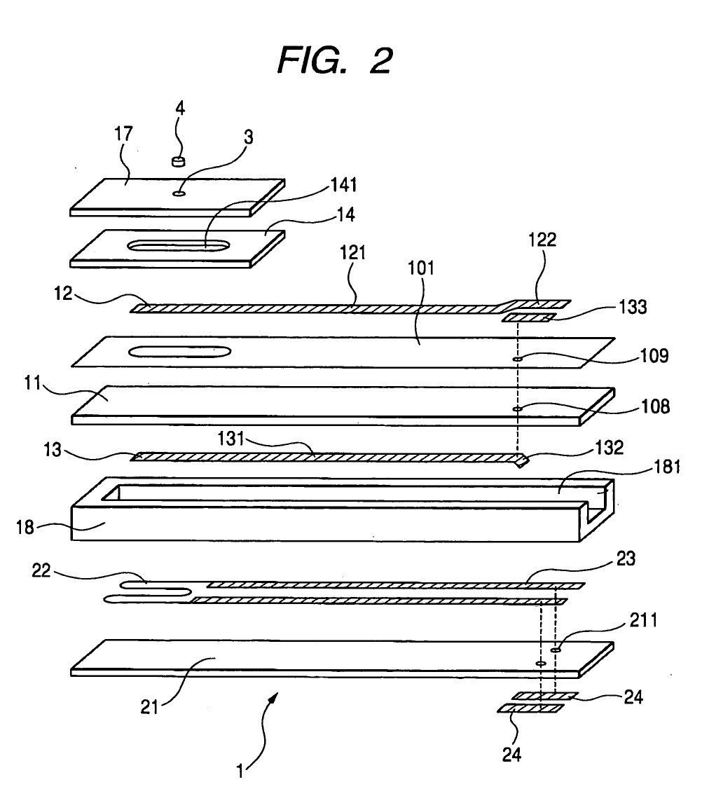

The gas sensing element 1, as shown in FIGS. 1 and 2, includes a chamber forming layer 14 and a cover shielding layer 17 which are successively laminated on one surface of solid electrolyte body 11. The chamber forming layer 14 has an open portion 141 which defines the chamber space 140. The shielding layer 17 covers the chamber forming layer 14. Each of the chamber forming layer 14 and the shielding layer 17 is made of a gas impermeable dense material. The introducing hole 3 is formed in the shielding layer 17. A practical opening diameter of the introducing hole 3 is, for example, in a range from 50 to 250 μm.

Furthermore, an overall cross-sectional area T at the narrowest portion of the introducing hole 3 and a thickness D of the shielding layer 17 are in a relationship of 0.005≦To/D²≦0.5. According to this embodiment, only one introducing hole 3 is formed in the shielding layer 17. The cross-sectional area To of the introducing hole 3 is constant irrespective of the distance from the chamber space 140. Therefore, the above-described overall cross-sectional area T at the narrowest portion is identical with the above-described cross-sectional area To. Therefore, the above-described cross-sectional area To and the above-described thickness D satisfy the relationship of 0.005≦To/D²≦0.5.

Furthermore, the overall cross-sectional area T at the narrowest portion of the introducing hole 3 and an area S of the shielding layer 17 facing to the chamber space 140 are in the relationship of 1.0×10⁻⁵≦T/S≦5.0×10⁻³. As described above, the overall cross-sectional area T at the narrowest portion is identical with the above-described cross-sectional area To. Thus, the cross-sectional area To and the above-described area S satisfy the relationship of 1.0×10⁻⁵≦To/S≦5.0×10⁻³.

It is possible to provide a plurality of introducing holes 3 having small opening diameters (although it is impossible to form a pore having a pore diameter exceeding the opening diameter of the introducing hole 3). Furthermore, it is possible to obtain a desired sensor output by adjusting the opening diameter of each introducing hole 3 or the total number of introducing holes, or both of them.

Furthermore, the average pore diameter of the above-described porous member 4 is equal to or less than 30 μm. In practice, measurement of the average pore diameter becomes feasible when the statistical processing is executed on an image of pores obtained, for example, from an electron microscope.

Hereinafter, the gas sensing element of this embodiment will be explained in more detail. As shown in FIGS. 1 and 2, a dense gas-impermeable insulating layer 101 is provided on the upper surface of solid electrolyte body 11 having oxygen ionic conductivity. The insulating layer 101 is made of alumina, and the solid electrolyte body 11 is made of zirconia. The measured gas side electrode 12, made of platinum, is provided on the upper surface of insulating layer 101. A lead portion 121 and a terminal portion 122, provided together with the measured gas side electrode 12 on the upper surface of insulating layer 101, are electrically connected to the measured gas side electrode 12.

A chamber forming layer 14 is laminated on the solid electrolyte body 11 via the insulating layer 101. The chamber forming layer 14, made of electrically insulating, dense, and gas-impermeable alumina ceramic, has the open portion 141 arranging the chamber space 140. The shielding layer 17, made of dense and gas-sealing alumina ceramic, is laminated on the upper surface of chamber forming layer 14. The above-described introducing hole 3 is formed in the shielding layer 17. The introducing hole 3 is filled with the porous member 4. For example, the porous member 4 is an alumina porous member having the porosity of 60% and the average pore diameter of 8 μm.

In practice, the above-described porous member 4 can be obtained in the following manner. First, resin grains having diameters of approximately 10 μm are mixed by 60% by volume with alumina grains having diameters of several hundreds nm. Then, the introducing hole 3 is filled with this mixture. And then, the sensing element is sintered to heat the resin grains and let them disappear. As a result, the porous member 4 is formed in the introducing hole 3. The porous member 4 being thus formed through the sintering process has an average pore diameter of 8 to 10 μm. Although the bores of the porous member 4 are replacement of the resin grains having disappeared during the sintering process, these pores cause later shrinkage during the rest of the sintering process. This is the reason why the pore diameters of the porous member 4 become smaller than the original diameters of the resin grains.

Meanwhile, the reference gas side electrode 13, made of platinum, is provided on the lower surface of solid electrolyte body 11 together with a lead portion 131 and a terminal portion 132 being electrically connected to the reference gas side electrode 13. In other words, measured gas side electrode 12 and the reference gas side electrode 13 are provided on opposite surfaces of the solid electrolyte body 11. Furthermore, the above-described terminal portion 132 is electrically connected to a terminal 133 provided on the upper surface of insulting layer 101 via a through-hole 108 of the solid electrolyte body 11 and a through-hole 109 of the insulating layer 101 which are both filled with conductive materials.

A reference gas chamber forming layer 18, made of electrically insulating, dense, and gas-impermeable alumina ceramic, is laminated on the lower surface of solid electrolyte body 11. The reference gas chamber forming layer 18 has a groove portion 181 which serves as a reference gas chamber 180. For example, air (i.e. a reference gas) is introduced into the reference gas chamber 180.

Furthermore, a heater board 21 is laminated on the lower surface of reference gas chamber forming layer 18. A heating element 22 and lead portions 23 are provided on the upper surface of heater board 21. The heating element 22 generates heat in response to supplied electric power. Electric power is supplied via the lead portions 23 to the heating element 22. In other words, the heating element 22 and the lead portions 23 are sandwiched between the reference gas chamber forming layer 18 and the heater board 21. Furthermore, terminal portions 24 are provided on the lower surface of the heater board 21 where the heating element 22 and the lead portion 23 are not provided. The terminal portions 24 are electrically connected to the lead portions 23 via through-holes 211 of the heater board 21 being filled with conductive members.

The introducing hole 3 can be formed in the shielding layer 17 in the following manner. For example, it is preferable to form a through-hole at a predetermined position of the green sheet of shielding layer 17 with a punching pin before the green sheet is sintered. Furthermore, the above-described porous member 4 can be formed before sintering the green sheet of shielding layer 17. For example, after the introducing hole 3 is formed in the green sheet of shielding layer 17, the introducing hole 3 is filled with the above-described mixture of the resin and alumina grains. Then, the shielding layer 17 and the above-described resin/alumina mixture are sintering together to form the porous member 4 in the introducing hole 3 of the shielding layer 17. Alternatively, it is possible to once obtain the shielding layer 17 having been sintered and fill the introducing hole 3 with the above-described resin/alumina mixture, and then sinter them to form the porous member 4 in the introducing hole 3 of the shielding layer 17.

The above-described gas sensing element 1 is assembled in a gas sensor and installed into an exhaust system of an internal combustion engine. In the installed condition, the introducing hole 3 of the gas sensing element 1 connects the above-described chamber space 140 to the inside of an exhaust pipe of the internal combustion engine (i.e. to a measured gas atmosphere) outside of the gas sensing element 1.

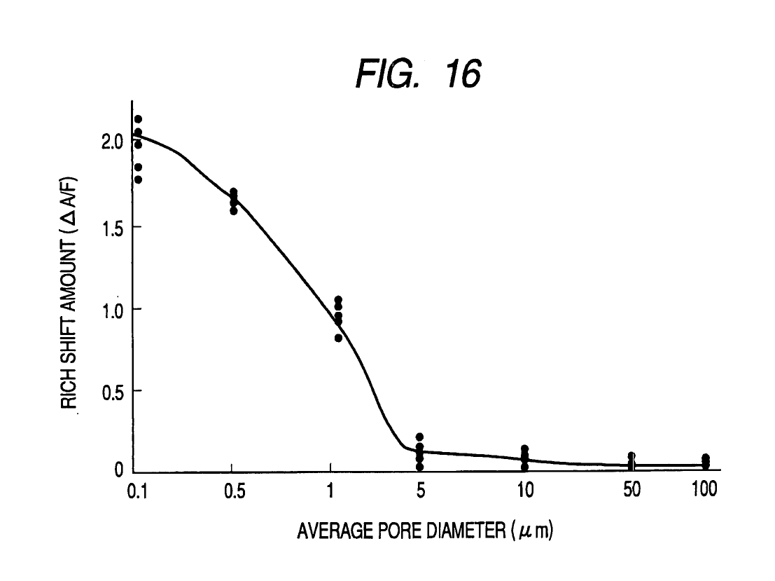

The above-described gas sensing element of this embodiment brings the following functions and effects. The porous member 4 of this embodiment has the average pore diameter equal to or greater than 2 μm. Therefore, it becomes possible to reduce the diffusion resistance and the water adhering to the porous member 4 can be promptly discharged to the outside. In general, water vapors contained in the measured gas atmosphere possibly adhere to the porous member 4. When the internal combustion engine starts its operation, the water removes from the porous member 4 due to the heat. However, according to this embodiment, the water (water vapors) can promptly exit out of the gas sensing element because the porous member 4 has a larger average pore diameter as described above. Hence, the gas sensing element 1 according to this embodiment can prevent the water vapor pressure from undesirably increasing in the chamber space 140 and also can reduce or eliminate the rich shift phenomenon appearing in the sensor output (refer to experimental data shown in FIG. 16).

Furthermore, having the average pore diameter equal to or greater than 2 μm brings the effects of reducing the surface area of the porous member 4 exposed to the measured gas, reducing an adsorption amount of the water in the measured gas, and suppressing generation of the rich shift phenomenon. Furthermore, as the average pore diameter of the porous member 4 is equal to or less than 30 μm, it becomes possible to suppress harmful substances (including Pb, P, and S) from entering into the chamber space 140 and accordingly the electrode materials can be prevented from being exposed to such harmful substances.

Furthermore, setting the above-described average pore diameter to be equal to or greater than 5 μm makes it possible to promptly and sufficiently discharge the water adhering to the porous member 4 to the outside and also makes it possible to sufficiently reduce the surface area of the porous member 4 exposed to the measured gas. With this arrangement, generation of the rich shift phenomenon can be sufficiently suppressed.

Furthermore, as the porous member 4 has the porosity of 30 to 75% by volume, it becomes possible to obtain uniform distribution of pores with less dispersion. Therefore, it becomes to obtain the effect of sufficiently discharging the water in the beginning of engine operations. Furthermore, when the porous member 4 has the porosity of 50 to 75% by volume, generation of the rich shift phenomenon can be surely suppressed.

Furthermore, the gas sensing element 1 includes the chamber forming layer 14 and the shielding layer 17 which are successively laminated on one surface of the solid electrolyte body 11. Each of the chamber forming layer 14 and the shielding layer 17 is made of a gas impermeable and dense material. Therefore, the gas sensing element according to this embodiment is easy to manufacture and excellent in strength.

Furthermore, as the introducing hole 3 is formed in the shielding layer 17, the introducing hole 3 can be easily formed. Furthermore, the cross-sectional area To of the introducing hole 3 and the thickness D of the shielding layer 17 are in the relationship of 0.005≦To/D²≦0.5. Therefore, the measured gas can be sufficiently introduced into the chamber space 140. The gas sensing element 1 can have sufficient strength.

Furthermore, the cross-sectional area To of the introducing hole 3 and the area S of the shielding layer 17 facing to the chamber space 140 are in the relationship of 1.0×10⁻⁵≦To/S≦5.0×10⁻³. Therefore, the measured gas can be sufficiently introduced into the chamber space 140. The gas sensing element 1 can have sufficient strength.

As described above, this embodiment can provide a gas sensing element capable of suppressing the rich shift phenomenon appearing in the sensor output.

### SECOND EMBODIMENT

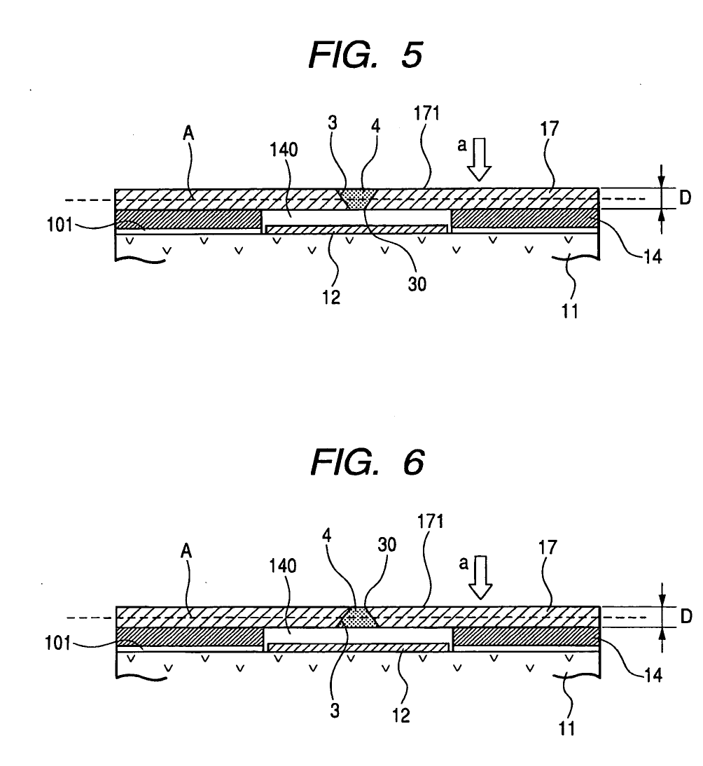

This embodiment is, as shown in FIGS. 5 and 6, characterized in that the gas sensing element 1 of the first embodiment is modified in that the introducing hole 3 has a cross-sectional area changing in accordance with the distance from the chamber space 140. For example, as shown in FIG. 5, it is preferable to form the introducing hole 3 whose cross-sectional area becomes larger when the distance from the chamber space 140 increases. To the contrary, as shown in FIG. 6, it is possible to form the introducing hole 3 whose cross-sectional area becomes smaller when the distance from the chamber space 140 increases.

Furthermore, according to this embodiment, the overall cross-sectional area T at the narrowest portion of the introducing hole 3, the thickness D of the shielding layer 17, and the area S of the shielding layer 17 facing to the chamber space 140 are in the relationships of 0.005≦T/D²≦0.5 and 1.0×10⁻⁵≦T/S≦5.0×10⁻³. According to this embodiment, as apparent from FIGS. 5 and 6, the overall cross-sectional area T at the narrowest portion of the introducing hole 3 is the cross-sectional area at a narrowest portion 30 of the introducing hole 3. However, in a case that a plurality of introducing holes 3 are formed in the shielding layer 17 (although not shown in the drawing), the overall cross-sectional area T at the narrowest portion is a sum of cross-sectional areas at respective narrowest portions 30 of the introducing holes 3. And, even in this case, the overall cross-sectional area T satisfies the above-described conditions. The introducing holes 3 shown in FIGS. 5 and 6 can be formed with a conical punching pin, since forming a conical hole on a green sheet of the shielding layer 17 can be easily performed by punching. The rest of the arrangement of this embodiment is similar to that of the first embodiment.

According to this embodiment, the output adjustment for the gas sensing element 1 can be easily performed. The sensor output is determined according to the diffusion resistance of the above-described porous member 4 of the gas sensing element 1. The diffusion resistance changes depending on the gas introducing cross-sectional area and the diffusion distance. The gas introducing cross-sectional area depends on the cross-sectional area of introducing hole 3. The diffusion distance changes depending on the length of introducing hole 3. Namely, the sensor output becomes larger when the cross-sectional area of introducing hole 3 is large and the length of introducing hole 3 is short. Hence, grinding the outer surface of gas sensing element 1 toward the chamber space 140 at the region including the introducing hole 3 makes it possible to adjust the length of introducing hole 3 (i.e. adjust the diffusion distance) and, as a result, makes it possible to adjust the sensor output.

More specifically, the grinding operation is applied to an outer surface 171 of shielding layer 17 in the direction normal to the shielding layer 17 as shown by an arrow ‘a’ in FIGS. 4 to 6, so that the shielding layer 17 has a reduced thickness as shown by a broken line ‘A’. As a result, the length of introducing hole 3 becomes shorter. The length of porous member 4 becomes shorter. And, the diffusion distance of the measured gas becomes shorter.

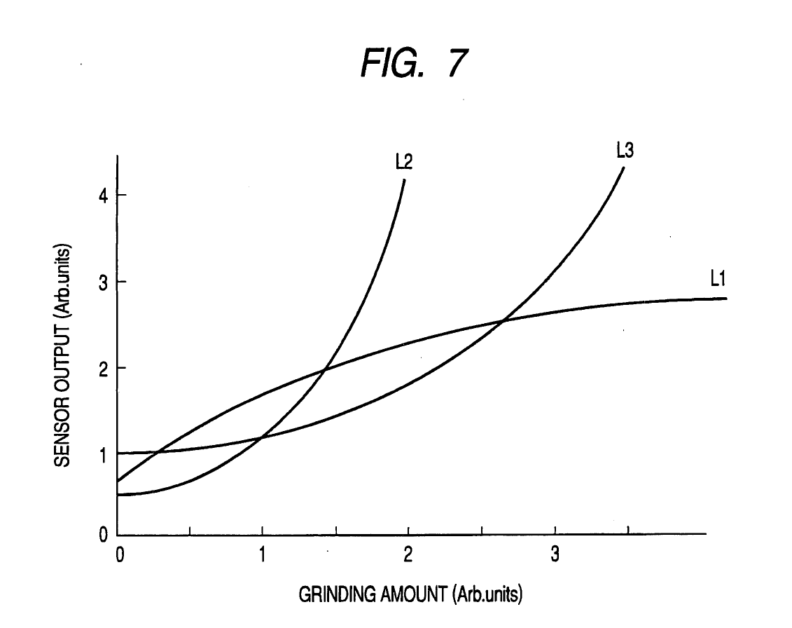

First, in the case of the introducing hole 3 shown in FIG. 5, the diffusion distance becomes shorter while the gas introducing cross-sectional area becomes smaller in accordance with the progress of the grinding operation. Therefore, as indicated by a curve L1 in FIG. 7, the sensor output does not increase so quickly. Thus, the sensor output increases with a relatively low rate when the grinding amount increases. On the other hand, in the case of the introducing hole 3 shown in FIG. 6, the diffusion distance becomes shorter while the gas introducing cross-sectional area becomes larger in accordance with the progress of the grinding operation. Therefore, as indicated by a curve L2 in FIG. 7, the sensor output increases quickly. Thus, the sensor output increases with a high rate when the grinding amount increases.

If the cross-sectional area of introducing hole 3 is constant irrespective of the distance from the chamber space 14 (like the introducing hole 3 of the first embodiment shown in FIG. 4), the sensor output becomes larger at a medium rate when the grinding amount increases (refer to a curve L3 in FIG. 7). As understood from comparison among curves L1, L2 and L3, changing the cross-sectional area of introducing hole 3 in accordance with the distance from the chamber space 140 makes it possible to arbitrarily increase or decrease the rate of the sensor output increasing in accordance with the grinding amount.

Thus, according to this embodiment, it becomes possible to optimize the increase rate of the sensor output with reference to, for example, the grinding accuracy. For example, when the arrangement of FIG. 5 is employed, fine adjustment for the sensor output is feasible even when the grinding accuracy is relatively low (refer to the curve L1 shown in FIG. 7). On the other hand, when the arrangement of FIG. 6 is employed, a grinding amount necessary for a required adjustment is relatively small because the sensor output greatly changes in accordance with the grinding amount (refer to the curve L2 shown in FIG. 7). Furthermore, this embodiment brings the functions and effects similar to those of the first embodiment. In FIG. 7, the numerical values of the ordinate (i.e. sensor output) and the abscissa (i.e. grinding amount) are expressed in the relative units (arb. units).

### THIRD EMBODIMENT

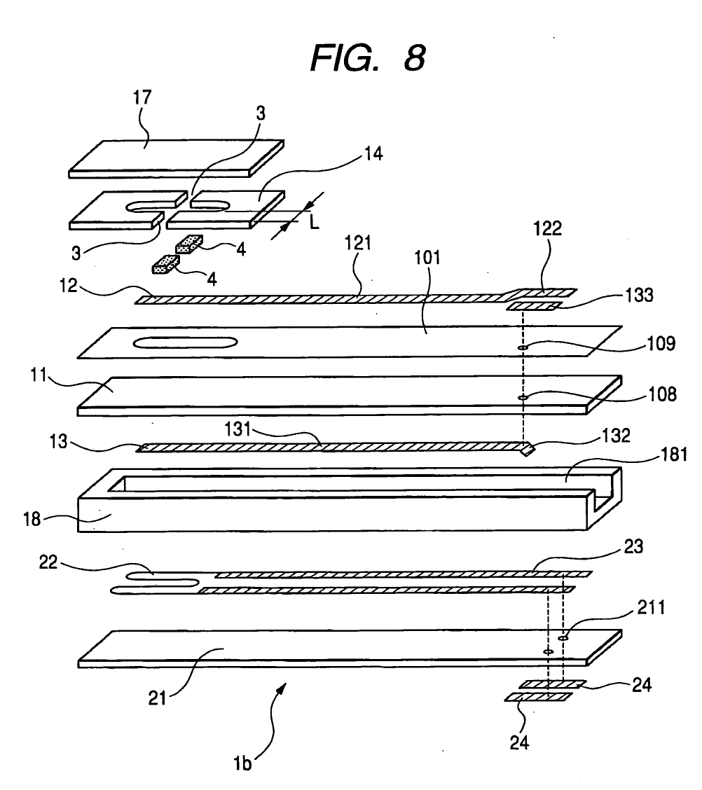

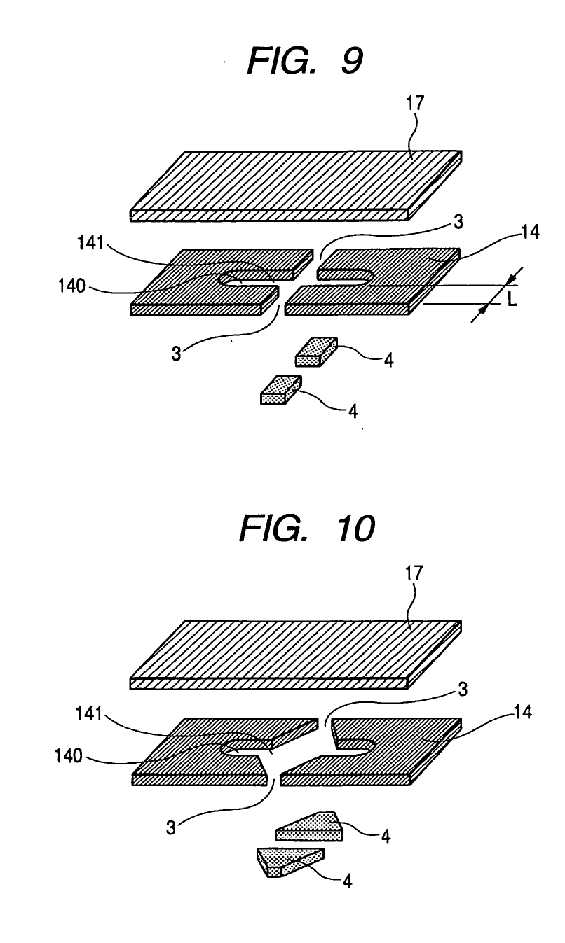

This embodiment is, as shown in FIGS. 8 and 9, a gas sensing element 1b characterized in that the introducing hole 3 is formed in the chamber forming layer 14. The introducing hole 3 of this embodiment extends in a direction normal to the axial direction of gas sensing element 1b so as to connect the chamber space 140 to the measured gas atmosphere outside of the gas sensing element 1b.

More specifically, the introducing hole 3 consists of two slits each extending in the direction normal to the axial direction of gas sensing element 1b from an open portion 141 of the chamber forming layer 14 to the outside of the gas sensing element 1b. Each slit of the introducing hole 3 is filled with the porous member 4. Furthermore, the porous member 4 can be formed before sintering the green sheet of chamber forming layer 14. For example, after the introducing hole 3 is formed in the green sheet of chamber forming layer 14, the introducing hole 3 is filled with the above-described mixture of the resin and alumina grains. Then, the chamber forming layer 14 and the above-described resin/alumina mixture are sintering together to form the porous member 4 in the introducing hole 3 of the chamber forming layer 14. Alternatively, it is possible to once obtain the chamber forming layer 14 having been sintered and fill the introducing hole 3 with the above-described resin/alumina mixture, and then sinter them to form the porous member 4 in the introducing hole 3 of the chamber forming layer 14.

Furthermore, the overall cross-sectional area T at the narrowest portion of the introducing hole 3 and the distance L from the gas introducing port of introducing hole 3 to the chamber space are in a relationship of 0.01≦T/L²=0.8. The width of introducing hole 3 is, for example, in the range of 100 to 6000 μm. It is however possible to form the introducing hole 3 in the insulating layer 101. The rest of the arrangement of this embodiment is similar to that of the first embodiment.

According to this embodiment, the introducing hole 3 can be selected from various kinds of introducing holes (which are mutually different in their shapes). Furthermore, satisfying the relationship 0.01≦T/L²≦0.8 between the overall cross-sectional area T at the narrowest portion of the introducing hole 3 and the distance L from the gas introducing port of introducing hole 3 to the chamber space makes it possible to sufficiently introduce the measured gas into the chamber space 140 and secure sufficient strength for the gas sensing element 1b. Furthermore, the introducing hole 3 of this embodiment is formed symmetrically at different portions. This is advantageous in that undesirable directional dependency in the output of gas sensing element 1b can be reduced. Furthermore, this embodiment brings the functions and effects similar to those of the first embodiment.

### FOURTH EMBODIMENT

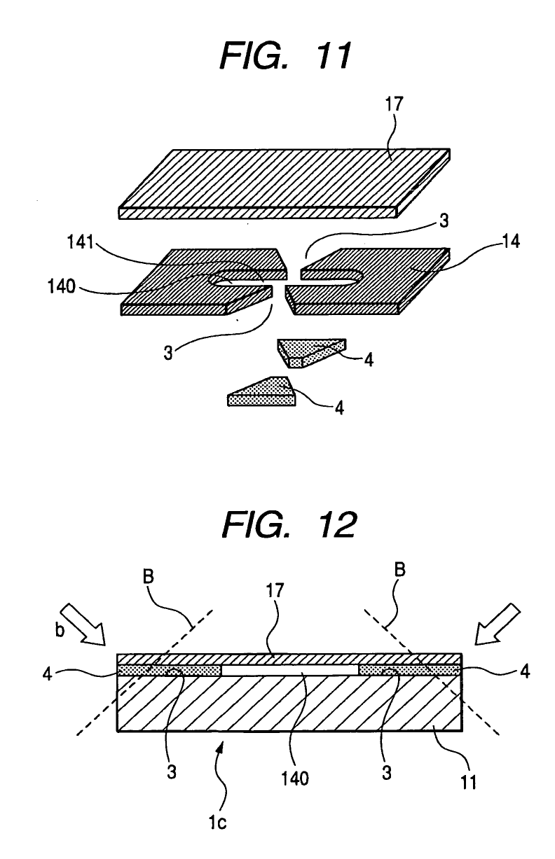

This embodiment is, as shown in FIGS. 10 to 12, is a gas sensing element 1c different from the gas sensing element 1b of the third embodiment in that the introducing hole 3 has a cross-sectional area changing in accordance with the distance from the chamber space 140. For example, according to the introducing hole 3 shown in FIG. 10, the cross-sectional area becomes smaller when the distance from the chamber space 140 increases. To the contrary, according to the introducing hole 3 shown in FIG. 11, the cross-sectional area becomes larger when the distance from the chamber space 140 increases. The rest of the arrangement of this embodiment is similar to that of the third embodiment.

According to this embodiment, like the second embodiment, the output adjustment for the gas sensing element 1c can be easily performed. The sensor output adjustment of the gas sensing element 1c includes grinding the sensor body obliquely from its angled side edge as indicated by an arrow ‘b’ in FIG. 12 to form an inclined surface indicated by a broken line B. With this grinding operation, the width of chamber forming layer 14 can be decreased. In other words, this embodiment can adjust the sensor output by reducing the length of introducing hole 3. In FIG. 12, for the purpose of simplifying the illustration of the gas sensing element 1c, the layers other than the shielding layer 17, the porous member 4 (chamber forming layer 14), and the solid electrolyte body 11 are omitted. Furthermore, this embodiment brings the functions and effects similar to those of the third embodiment.

### FIFTH EMBODIMENT

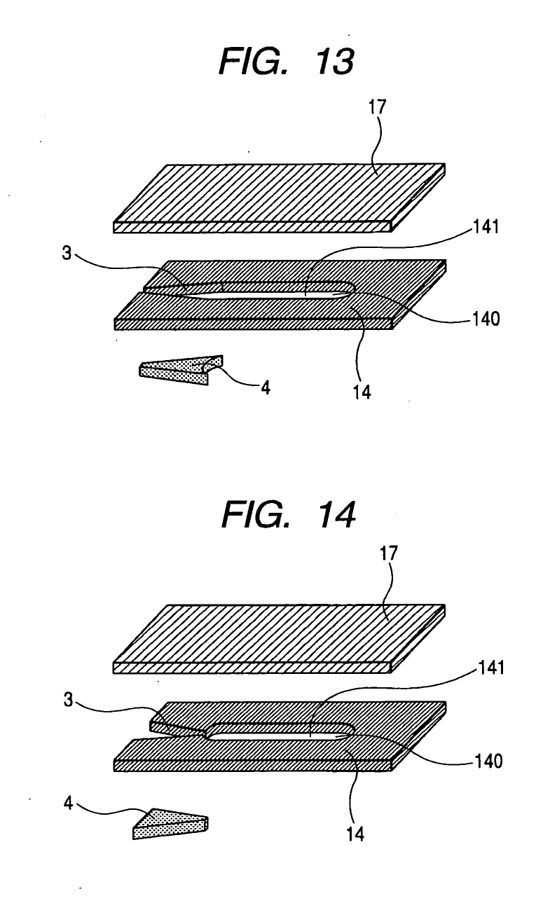

This embodiment is, as shown in FIGS. 13 to 15, a gas sensing element 1d characterized in that the introducing hole 3 is formed at the front end side of the chamber forming layer 14. For example, according to the introducing hole 3 shown in FIG. 13, the cross-sectional area becomes smaller when the distance from the chamber space 140 increases. To the contrary, according to the introducing hole 3 shown in FIG. 14, the cross-sectional area becomes larger when the distance from the chamber space 140 increases. Furthermore, although not shown in the drawing, it is possible to form the introducing hole 3 having a constant cross-sectional area irrespective to the distance from the chamber space 140. The rest of the arrangement of this embodiment is similar to that of the third embodiment.

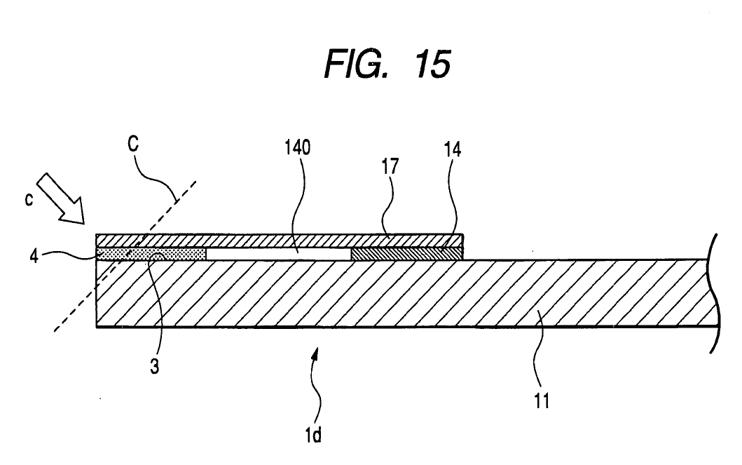

According to this embodiment, the sensor output adjustment for the gas sensing element 1d includes grinding the sensor body obliquely from its angled front edge as indicated by an arrow ‘c’ in FIG. 15 to form an inclined surface indicated by a broken line C. With this grinding operation, this embodiment can adjust the sensor output by reducing the length of introducing hole 3. Thus, adjustment for the sensor output can be easily performed. In FIG. 15, for the purpose of simplifying the illustration of the gas sensing element 1d, the layers other than the shielding layer 17, the chamber forming layer 14, and the solid electrolyte body 11 are omitted. Furthermore, this embodiment brings the functions and effects similar to those of the third embodiment.

### Experimental Data

FIG. 16 shows experimental data of the gas sensing element according to the above-described first embodiment, measured to check the relationship between the average pore diameter of the porous member and the rich shift amount. For the measurement, various kinds of gas sensing elements are prepared as test samples having different average pore diameters.

More specifically, a total of seven kinds of prepared samples are differentiated in the average pore diameter of the porous member, as comparative sample 1 (average pore diameter=0.1 μm), comparative sample 2 (0.5 μm), comparative sample 3 (1 μm), sample 1 (5 μm), sample 2 (10 μm), sample 3 (50 μm), and sample 4 (100 μm). The samples 1 to 4 are examples of the gas sensing element of the present invention.

A total of five sensors were prepared for each type of the above seven kinds of samples. FIG. 16 shows the plots of measured values with respect to the rich shift amount of respective samples. To measure the rich shift amount, respective test samples were exposed to the following pseudo environment which tends to cause the rich shift phenomenon. More specifically, the temperature of the pseudo environment was set to 80° C. corresponding to the temperature of an exhaust pipe of an automotive internal combustion engine. The humidity of the pseudo environment was set to 95%. Each tested sample was left in the above highly-humid atmosphere for 15 hours prior to measurement of the rich shift amount. Adjustment for the sensor output of respective samples was conducted beforehand to show the same value in the same atmosphere. For example, when left in the air, all of the tested samples generate the sensor output of approximately 1.5 mA.

As understood from FIG. 16, the comparative samples 1 to 3 have the porous members whose average pore diameters are equal to or less than 1 m and showed the rich shift amount of approximately 1 to 2 (in terms of ΔA/F). On the other hand, the samples 1 to 4 have the porous members whose average pore diameters are equal to or greater than 5 μm and showed the rich shift amount of approximately 0.2 or less (in terms of ΔA/F). From the result of these experimental data, it is understood that the gas sensing element according to the present invention can sufficiently suppress the rich shift phenomenon.

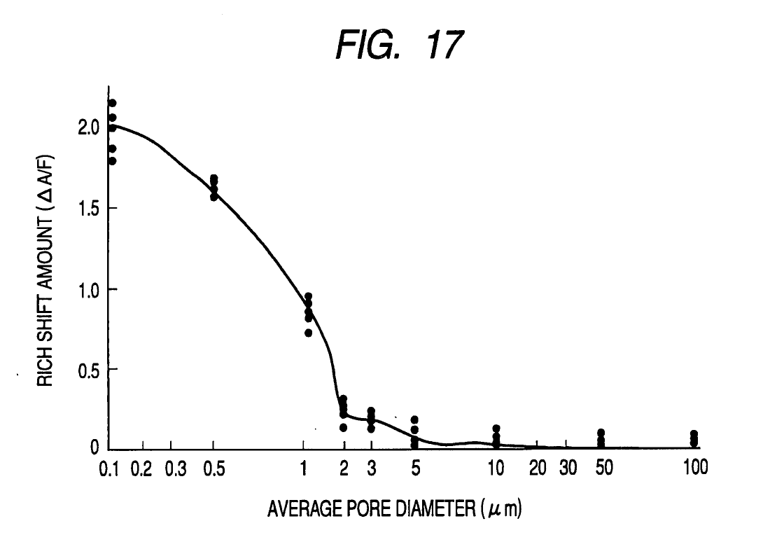

FIG. 17 shows experimental data of an additional test conducted to confirm the above-described relationship between the average pore diameter of the porous member and the rich shift amount. For this additional test, two different samples were newly added as sample 5 (average pore diameter=2 μm) and sample 6 (3 μm) in addition to the above seven samples of FIG. 16. The rest of experiment is similar to that of the above experiment.

As understood from FIG. 17, the comparative samples 1 to 3 (having the porous members whose average pore diameters are equal to or less than 1 μm) showed the rich shift amount of approximately 1 to 2 (in terms of ΔA/F). On the other hand, the samples 1 to 6 (having the porous members whose average pore diameters are equal to or greater than 2 μm) showed the rich shift amount of approximately 0.2 or less (in terms of ΔA/F).

Furthermore, as understood from FIG. 17, the samples having the porous members whose average pore diameters are equal to or greater than 5 μm showed the rich shift amount of approximately 0.1 or less (in terms of ΔA/F). Thus, the rich shift phenomenon can be surely suppressed. From the result of these experimental data, it is understood that the gas sensing element according to the present invention can sufficiently suppress the rich shift phenomenon.

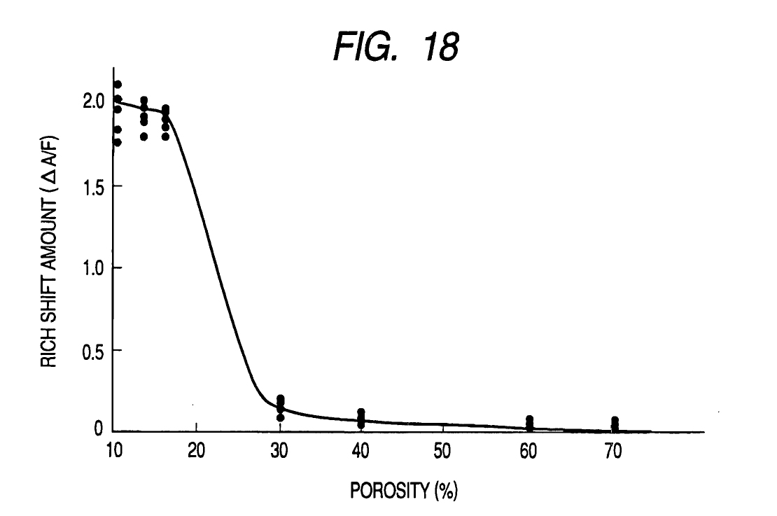

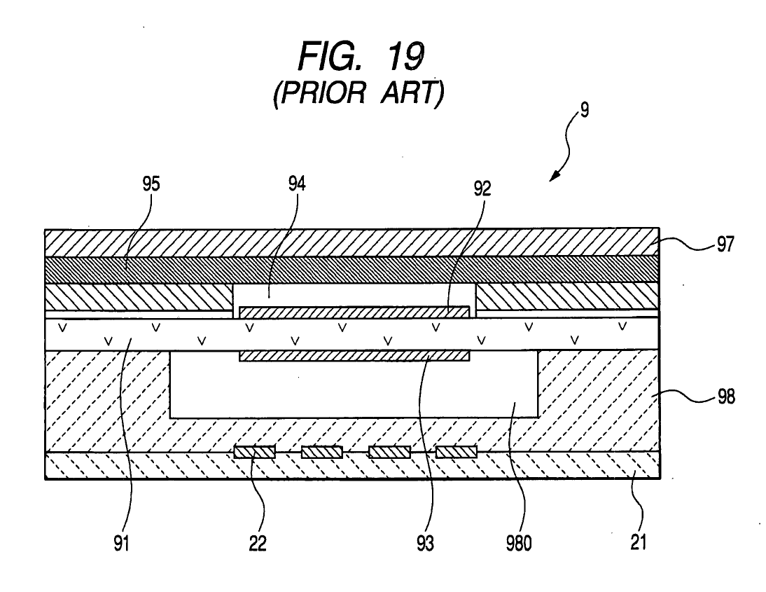

FIG. 18 shows experimental data of the gas sensing element of the present invention, measured according to the method similar to the above experiments to check the relationship between the porosity of the porous member and the rich shift amount. More specifically, a total of seven kinds of prepared samples are differentiated in the porosity of the porous member, as sample 1 (porosity=10%), sample 2 (13%), sample 3 (16%), sample 4 (30%), sample 5 (40%), sample 6 (60%), and sample 7 (70%). The obtained test rest was similar to that of the above experiments.

As understood from FIG. 18, the comparative samples 1 to 3 have the porous members whose porosities are in the range of 10 to 20% and showed the rich shift amount of approximately 2 (in terms of ΔA/F). On the other hand, the samples 1 to 4 have the porous members whose porosities are equal to or greater than 30% and showed the rich shift amount of approximately 0.2 or less (in terms of ΔA/F). From the result of these experimental data, it is understood that the gas sensing element according to the present invention can sufficiently suppress the rich shift phenomenon by setting the porosity to be equal to or greater than 30%.

1. A gas sensing element comprising:
a solid electrolyte body having oxygen ionic conductivity;
a measured gas side electrode provided on one surface of said solid electrolyte body;
a reference gas side electrode provided on the other surface of said solid electrolyte body; and
a chamber space in which said measured gas side electrode is positioned,
wherein
said gas sensing element has an introducing hole connecting said chamber space to a measured gas atmosphere outside of said gas sensing element, and
said introducing hole is filled with a porous member having an average pore diameter of 2 to 30 μm.

2. The gas sensing element in accordance with claim 1, wherein the average pore diameter of said porous member is equal to or greater than 5 μm.

3. The gas sensing element in accordance with claim 1, wherein said porous member has the porosity of 30 to 75% by volume.

4. The gas sensing element in accordance with claim 1, wherein said introducing hole has a cross-sectional area changing in accordance with a distance from said chamber space.

5. The gas sensing element in accordance with claim 1, wherein
said gas sensing element includes a chamber forming layer having an open portion for forming said chamber space and a shielding layer covering said chamber forming layer,
said chamber forming layer and said shielding layer are successively laminated on said one surface of said solid electrolyte body, and
each of said chamber forming layer and said shielding layer is made of a gas impermeable dense material.

6. The gas sensing element in accordance with claim 5, wherein said introducing hole is formed in said shielding layer.

7. The gas sensing element in accordance with claim 6, wherein an overall cross-sectional area T at a narrowest portion of said introducing hole and a thickness D of said shielding layer are in a relationship of 0.005≦T/D²≦0.5.

8. The gas sensing element in accordance with claim 6, wherein an overall cross-sectional area T at a narrowest portion of said introducing hole and an area S of said shielding layer facing to said chamber space are in a relationship of 1×10⁻⁵≦T/S≦5.0×10⁻³.

9. The gas sensing element in accordance with claim 5, wherein said introducing hole is formed in said chamber forming layer.

10. The gas sensing element in accordance with claim 9, wherein an overall cross-sectional area T at a narrowest portion of said introducing hole and a length L of said introducing hole are in a relationship of 0.01≦T/L²≦0.8.
